(19) United States
(12) Patent Application Publication
(10) Pub. No.: US 2010/0288212 A1
(43) Pub. Date: Nov. 18, 2010

(54) On demand system for using water (HHO) as a sole fuel

(76) Inventor: Norman Williams, Mount Vernon, NY (US)

Correspondence Address: Norman Williams, 2 Gramatan Avenue, Suite 305, Mt. Vernon, NY, 10550, US

(21) Appl. No.: 12/455,629

(22) Filed: Jun. 4, 2009

Related U.S. Application Data
(60) Provisional application No. 61/216,170, filed on May 14, 2009.

(51) Int. Cl. F02B 43/08

(52) U.S. Cl. 123/3

(57) ABSTRACT

The instant invention provides a system and apparatus for direct retrofit into any internal combustion engine a system and apparatus for an engine that uses only water as the raw fuel sources hydrogen, oxygen, and steam. The system is designed for on demand conversion of distilled water to hydrogen, oxygen and a slight amount of water vapor. Sensors, minor chamber modifications are the only minor changes to the original or OEM system provides an elegant answer to a question of alternative energy. With addition of multiple heat exchange units or steam generators, surplus energy is made.

### FIELD OF THE INVENTION

The present invention relates generally to an alternate fueled engine and more specifically to an engine that makes hydrogen on demand along with oxygen and water vapor for the ubiquitous gasoline engine.

### BACKGROUND OF THE INVENTION

With the dwindling cites to drill for oil upon, and the strategic increase in gas prices, our civilization must find alternatives to gasoline and other petroleum products. In fact, gasoline has long ago joined the ranks of historical strategic goods that have directly affected man's interaction and history on earth. In response to its strategic importance, man has tried many substitutions like ethanol, methanol, salad, frying and cooking oil, propane, liquid petroleum, various batteries and any other flammable material within perception.

One such fuel that is revisited periodically is hydrogen. Hydrogen, the explosive gas that floated and destroyed the graf Zeppelin in the same trip is the candidate of choice. Its reactive properties are close to gasoline, and it is imperative that any substitute fuel must retrofit without a clue that it is not the real thing. Hydrogen when stored as a gas in a tank is dangerous, but hydrogen stored as water HHO in a closed tank is relatively harmless.

One would expect a sizable number of references for the prior art relating to hydrogen used as a fuel. And indeed there are many references.

### OBJECTS OF THE INVENTION

It is the principal object of the present invention to provide an engine assemblage that runs principally on hydrogen, the hydrogen being derived from water, with oxygen and water vapor adding body to the fuel to approximate gasoline.

Another object of the present invention is to provide an engine that utilizes the instant technology to retrofit internal combustion engines without a major introduction of parts.

Yet another object of the present invention is to provide a hydrogen-based engine that will function in a way indistinguishable from 4-stroke internal combustion engines and present the consumer with a driving experience indistinguishable from what he/she already has become familiar.

And yet another object of the instant invention is to provide an engine that will function as intermediate technology until a succeeding technology may be decided upon by car manufacturers.

Another object of the present invention is to provide the consumer with a clean burning and non-polluting exhaust product. The combustion of hydrogen results in the re-bonding of the previously separated hydrogen and oxygen molecules, making the engine's exhaust water vapor, steam, and nothing and an insignificant amount of other products.

### SUMMARY OF THE INVENTION

The instant invention provides for the use of water to fuel any internal combustion engine. By introducing a one way valve before the fuel tank and after the electrolysis unit a closed system may be used to maintain the system (with continual feed of fuel) and in an off condition (to prevent the continual instillation of water into the electrolysis unit and from the electrolysis unit to the carburetor as hydrogen and oxygen gas). As the preferred embodiment the system uses some of the heated exhaust to raise the temperature of the water within the electrolysis unit. As a result of the copious amounts of heat generated thereby, one can utilize various heat exchange units, a Stirling Engine, Steam Generator, or any thermally actuated generator to produce enough electricity to charge a bank of batteries to service the starter engine, or produce enough voltage for unassisted electrical power for the car.

Therefore, it is inherent that the starter motor will provide the necessary applied energy to initiate combustion within the hydrogen engine to continue electrolysis and combustion of hydrogen oxygen and water vapor.

Prior Art

Individuals notably Daniel D. Dingel of the Philippines, claims to have a working hydrogen-powered car. The hydrogen being derived from water in an onboard fuel tank/water tank. Originally published in Manila Times in 1968, 1974, 1984 and 1994.

Internal Combustion Engines

In a petrol internal combustion engine, the throttle is a valve that directly regulates the amount of air entering the engine, indirectly controlling the fuel burned on each cycle due to the fuel-injector or carburetor maintaining a relatively constant fuel/air ratio. In a motor vehicle the control used by the driver to regulate power is sometimes called the throttle pedal or accelerator.

The throttle is typically a butterfly valve. In a fuel-injected engine, the throttle valve is housed in the throttle body. In a cabureted engine, it is found in the carburetor.

When a throttle is wide open, the intake manifold is usually at ambient atmospheric pressure. When the throttle is partially closed, a manifold vacuum develops as the intake drops below ambient pressure.

Usually the throttle valve is mechanically linked with the throttle pedal or lever. In vehicles with electronic throttle control, the throttle valve is electronically controlled, which allows the ECU greater possibilities in reducing air emissions.

Because diesel engines use compression ignition, they do not need to control air volumes or mixture (indeed this would be undesirable). Thus they lack a butterfly valve in the intake tract, and do not have a throttle (although recent developments in Exhaust Gas Recirculation have introduced throttle-style designs). They instead regulate engine power by directly controlling the quantity of fuel injected into the cylinder just before top dead center (TDC) of the compression stroke.

Environmental Aspects

Regulation of the throttle is also a mechanism for controlling engine exhaust emissions. In many modern internal combustion engines an electronic throttle is used, eliminating the older accelerator cable.

Throttle application was the accelerator pedal also results in increased sound emission from the engine. At lower operating speeds this component of vehicle noise is prominent contrasted with higher operating speeds, for which aerodynamic and tire noise are more significant.

Other Engines

Most engines have some kind of throttle control; through the particular way that power is regulated is often different.

Liquid rockets are throttled by controlling the pumps which send liquid fuel and oxidizer to the combustion chamber. Solid rockets are more difficult to throttle, but some may have mechanisms for this.

In a jet engine, engine output is also directly controlled by changing the amount of fuel flowing into the combustion chamber, usually with an autothrottle. In some instances, a “throttle” is known as a “thrust lever” (as in most Boeing Aircraft). This is chiefly due to the fact that a standard “throttle” is associated with internal combustion engines.

Jet Engines

Jet engine designs are frequently modified to turn them into gas turbine engines which are used in a wide variety of industrial applications. These include electrical power generation, powering water, natural gas, or oil pumps, and providing propulsion for ships and locomotives. Industrial gas turbine can create up to 50,000 shaft horsepower. Many of these engines are derived from older military turbojets such as the Pratt & Whitney 157 and 175 models. There is also a derivative of the P&W JT&D low-bypass turbofan that creates up to 35,000 HP.

Jet Engines in Use Today Follow:

Water jet

Motorjet

Turbojet

Low-bypass

Turbofan

High-bypass Turbofan

Rocket

Ranjet

Turboprop
(Turboshaft similar)

Propfan/Unducted Fan

Pulsejet

Pulse detonation engine

Air-augmented rocket

Scramjet

Turborocket

Precooled jets/LACE

Reciprocating Engine

There may be one or more pistons. Each piston is inside a cylinder, into which a gas is introduced, either already hot and under pressure (steam engine), or heated inside the cylinder either by ignition of a fuel air mixture (internal combustion engine) or by contact with a hot heat exchanger in the cylinder (stirling engine). The hot gases expand, pushing the piston to the bottom of the cylinder. The piston is returned to the cylinder top (Top Dead Centre) either by a flywheel or the power from other pistons connected to the same shaft. In most types the expanded or “exhausted” gases are removed from the cylinder by this stroke. The exception is the Stirling engine, which repeatedly heats and cools the same sealed quantity of gas.

In some designs the piston may be powered in both directions in the cylinder in which case it is said to be double acting.

In all types of linear movement of the piston is converted to a rotating movement via a connecting rod and a crankshaft or by a swashplate. A flywheel is often used to ensure smooth rotation. The more cylinders a reciprocating engine has, generally, the more vibration-free (smoothly) it can operate. The power of a reciprocating engine is proportional to the volume of the combined pistons' displacement.

A seal needs to be made between the sliding piston and the walls of the cylinder so that the high pressure gas above the piston does not leak past it.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is an elevational plan drawing generally showing the system for utilizing hydrogen on demand.

FIG. 2 is an elevational plan drawing of a jet engine being fueled by system thereof.

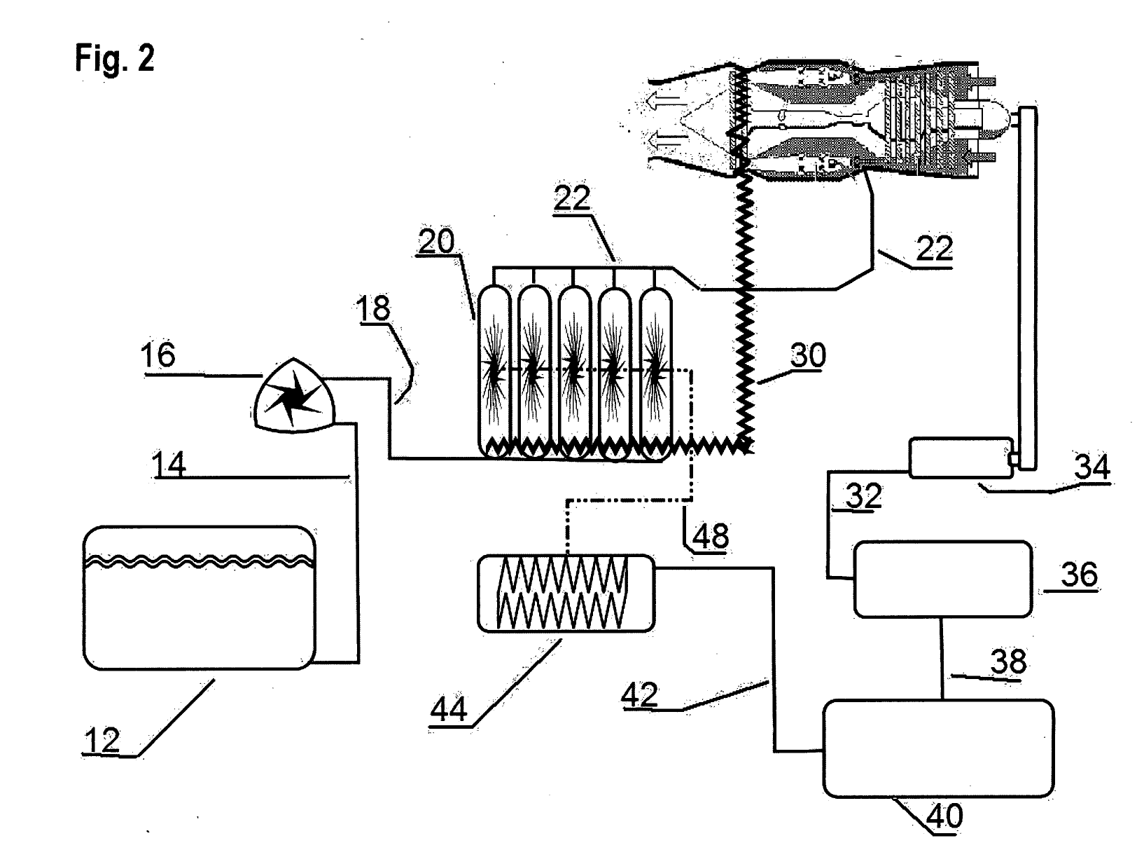

FIG. 3 is a diagrammatic view of the system thereof, in a single feed setup.

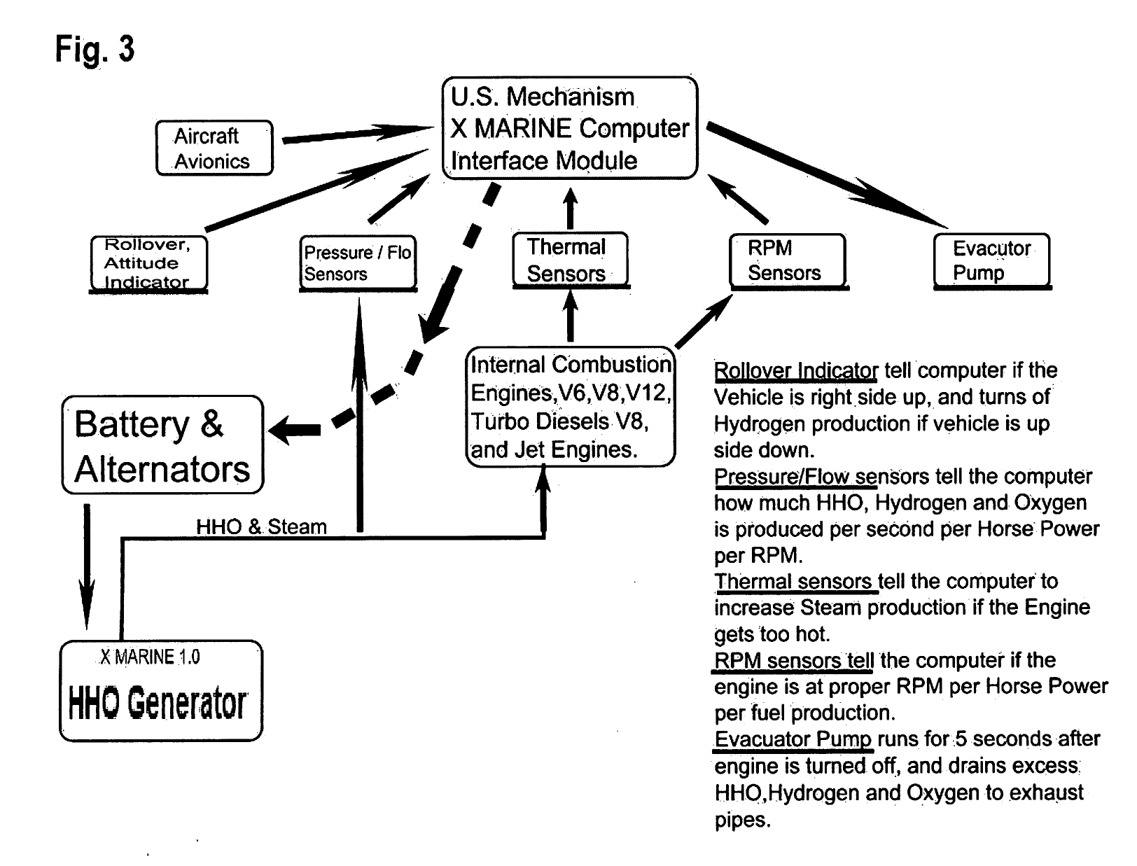

FIG. 4 is an elevated diagrammatic view of the computer interface and sensors system thereof, in a three feed setup.

FIG. 5 is a diagrammatic view of ignition sequence thereof.

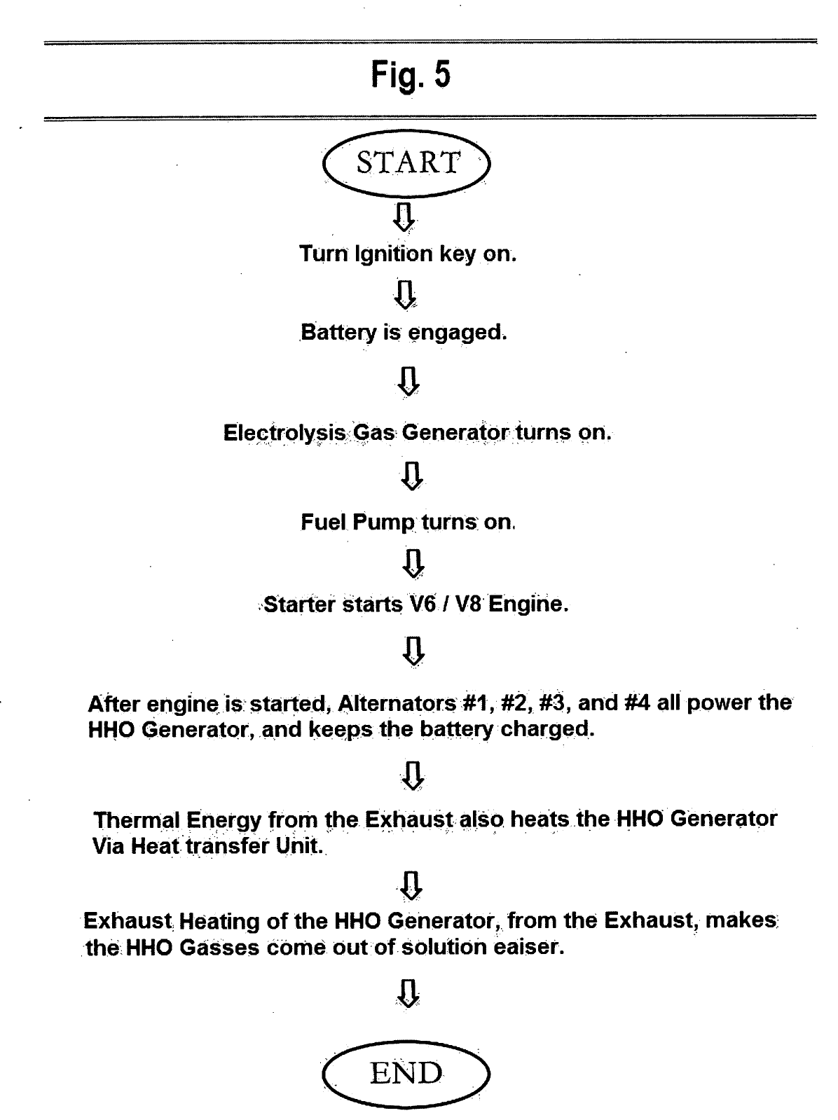

FIG. 6 is a diagrammatic view of a preferred shutdown sequence for the system thereof.

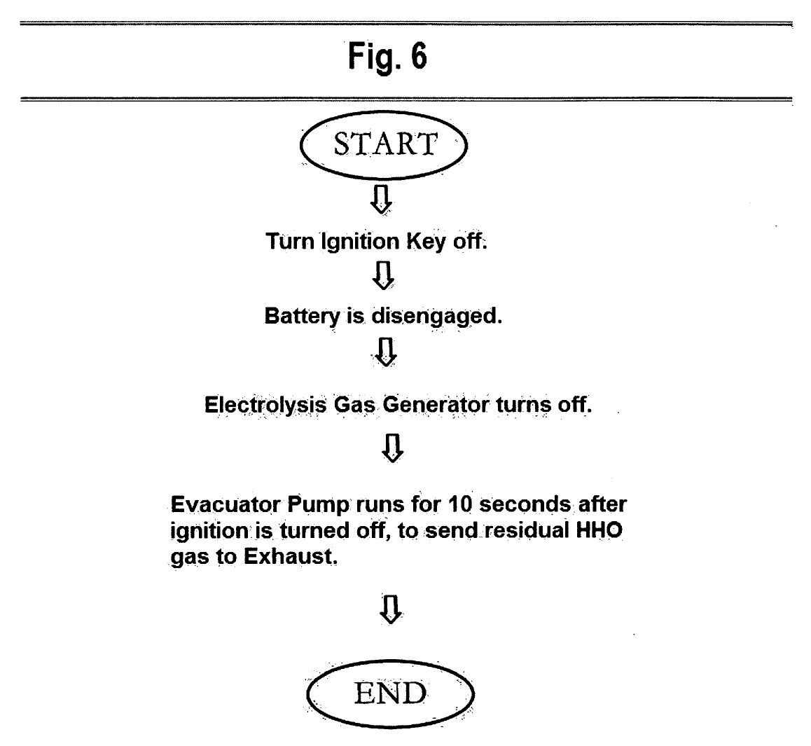

FIG. 7 is a more specific view taken from FIG. 6 showing a shutdown protocol for the electrolysis unit which endorses total evacuation of explosive gases.

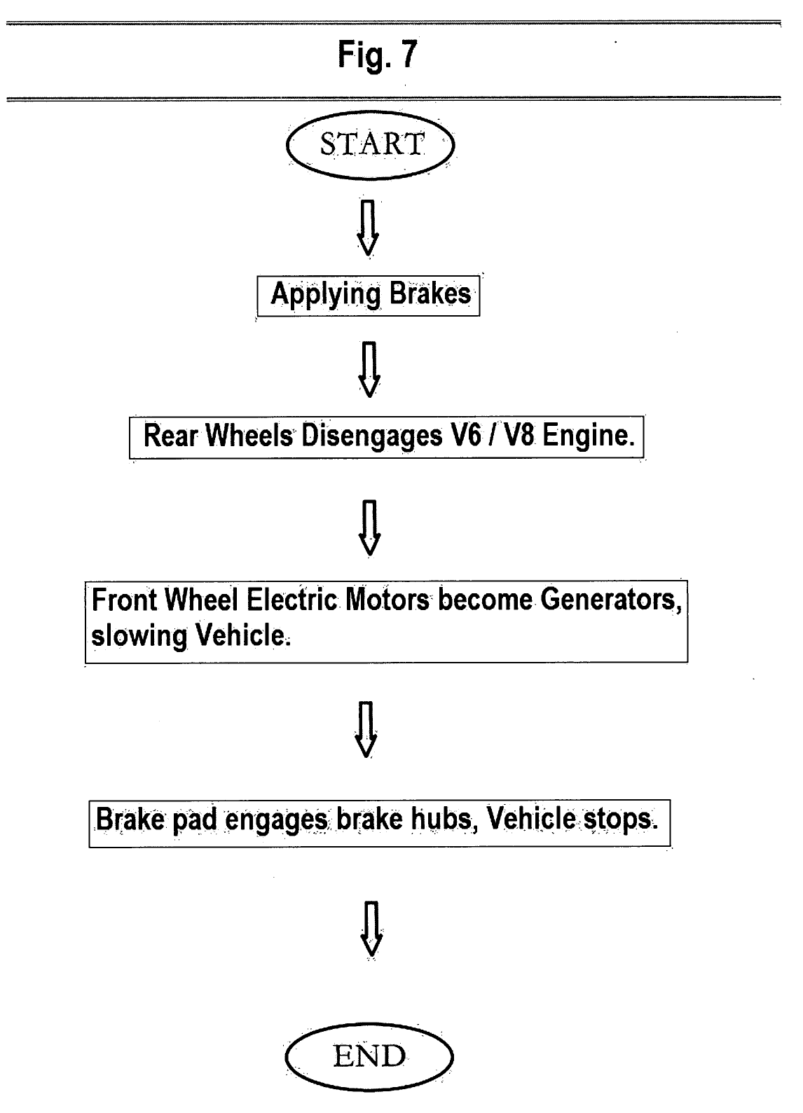

FIG. 8 is a diagrammatic view showing the initiation of the jet system thereof, and

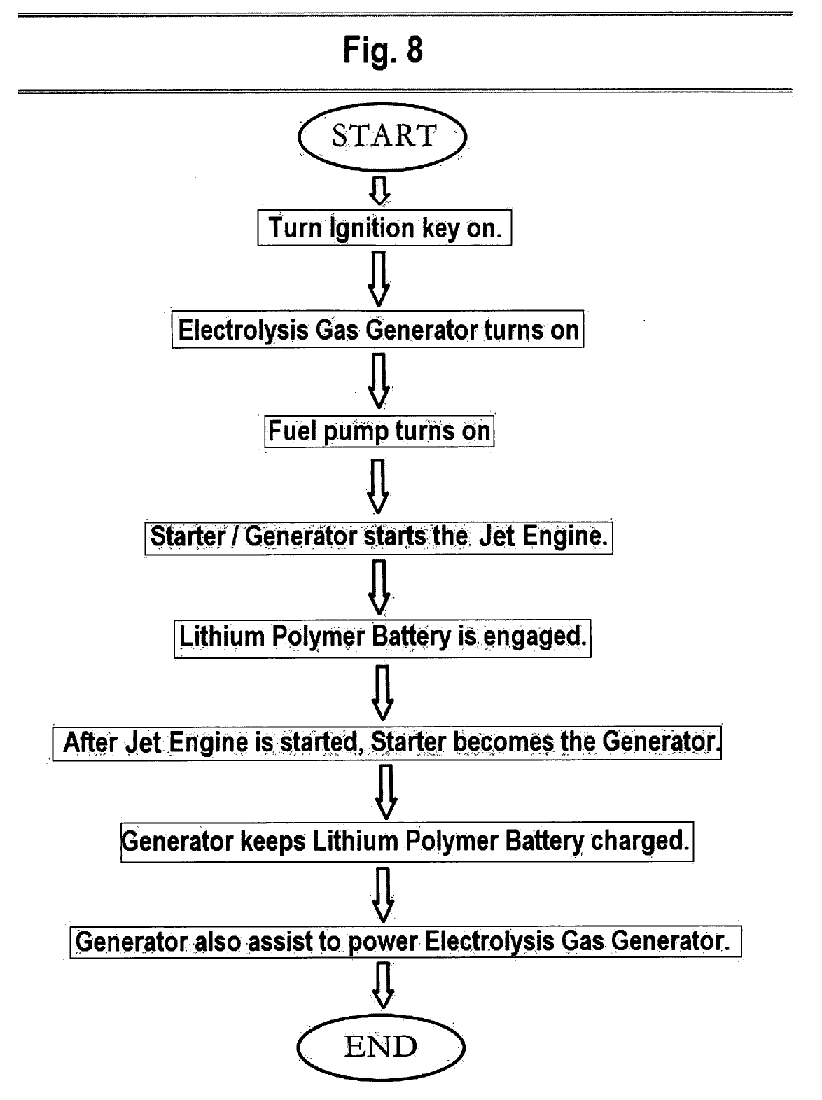

FIG. 9 is a plan drawing showing at least three ways of providing fuel to the combustion area with H, O and water vapor by the system hereof.

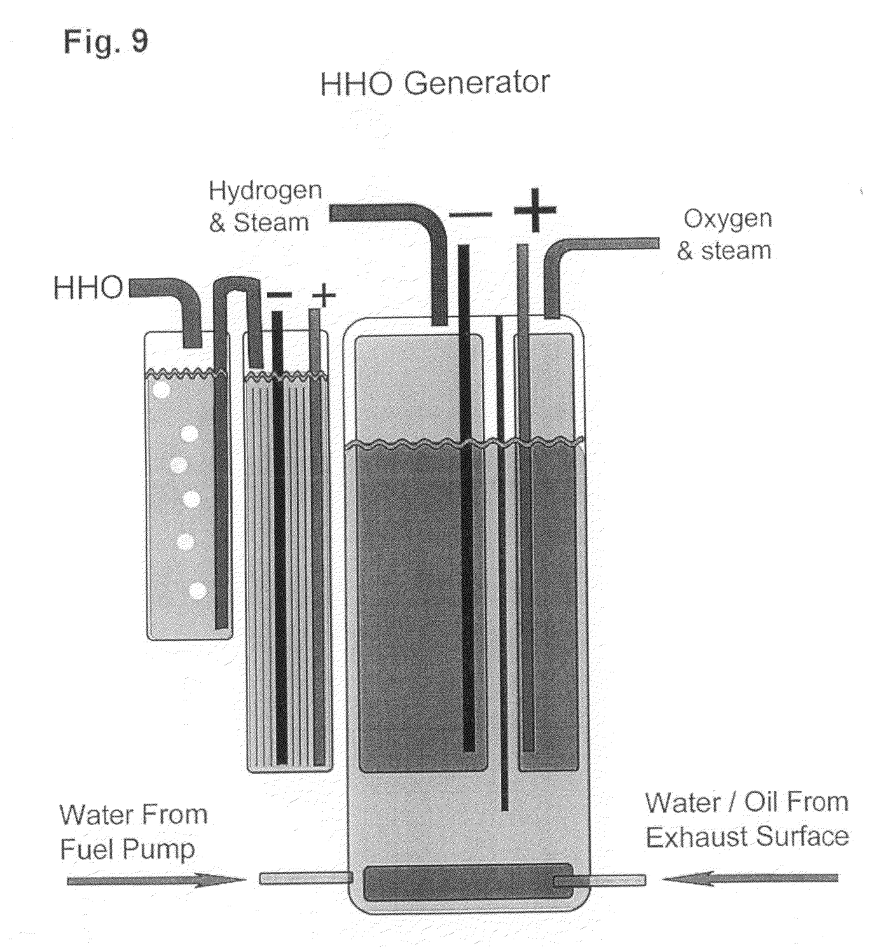

### DETAILED DESCRIPTION OF THE PREFERRED EMBODIMENTS

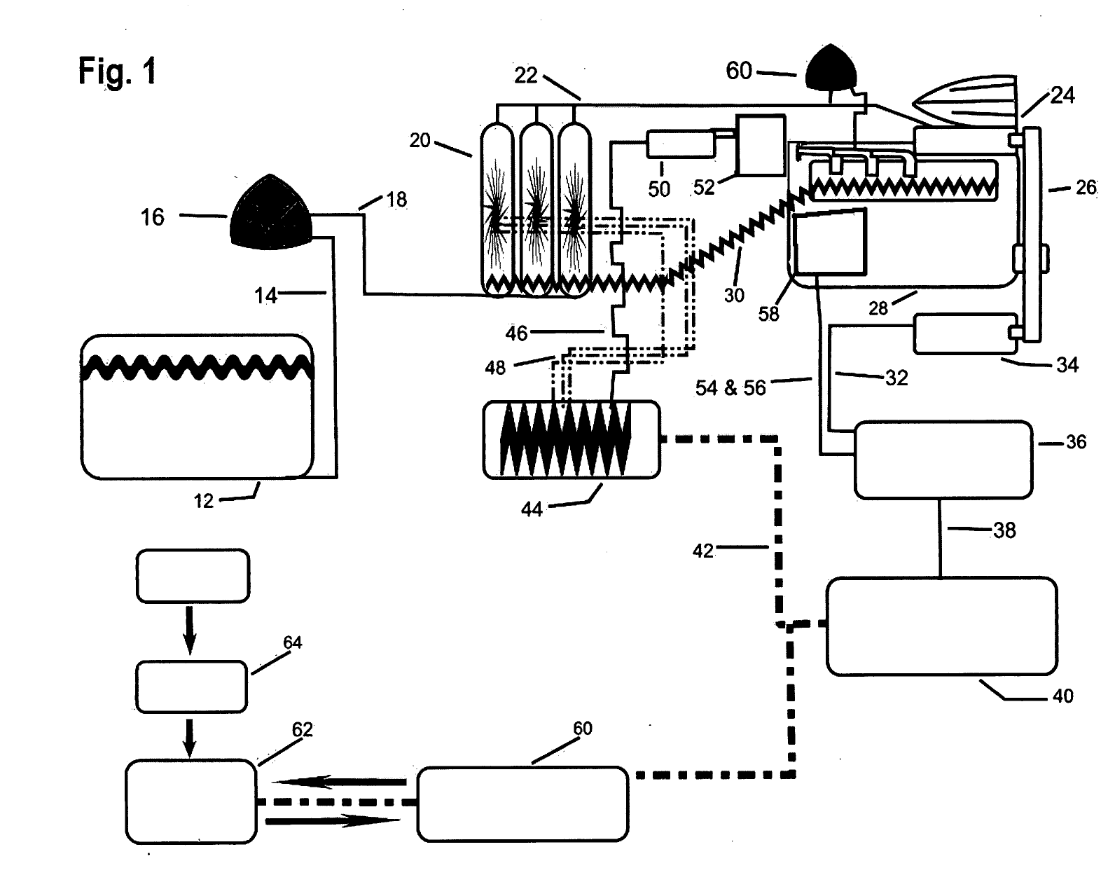

As a prefatory note it should be understood that the instant disclosure includes variations of materials and slight modifications of existing parts. For example, utilizing stainless steel for cast-iron would be a change contemplated within the present disclosure and this would not be anticipated from what is disclosed under Prior Art. Turning now to FIG. 1 wherein like numbers appertain to like parts throughout numeral 28 appertain to the engine generally. The engine must be set in motion by an external force before it can power itself.

From a purely practical standpoint, the instant invention provides the first and only engine that has been designed to use H20 as a constituent of the fuel from the beginning. Whether it is 3%, 13%, 23%, 50% or more, there has not been a single engine that utilizes water as a sole fuel. Indeed while water is one of the three dedicated lines, or conduits 14, 18 and 22. From fuel tank 12 an electrolysis unit 20 is responsible for cracking water into hydrogen and oxygen.

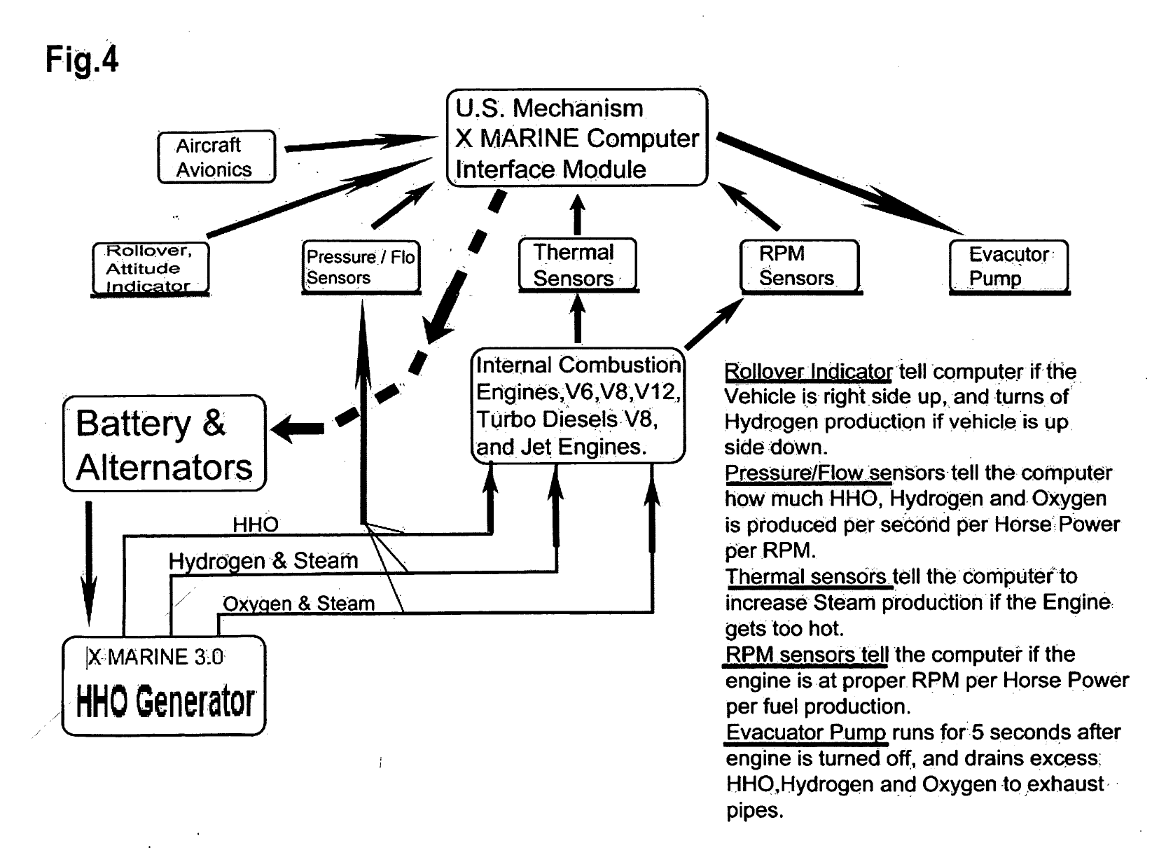

As the propagating flame encounters the tiny water droplets, they are vaporized into steam and expand dramatically. (Refer to FIG. 4). Although the vaporizing of the water droplets reduces the peak combustion temperature, the amount of energy consumed as the water undergoes a phase change generates a greater increase in pressure than would result if that same energy were utilized to heat and expand the air and combustion products normally encountered in the combustion chamber. In other words, we have some of the benefits of the Rankine-cycle device or a steam engine. After all, it is the pressure of the gases which force the piston down and not temperature. If a high pressure can be achieved inside the combustion chamber without high temperature, then all the better.

Such is the case with a well-designed water induction system on a hydrogen engine.

A typical intake manifold system with a water atomizing spray nozzle on the right side of the common air inlet. As can be seen, the stream of incoming air sweeps the water droplets into the intake manifold, with the majority of them ending up in cylinder number four. A similar nozzle installed over the inlet to each cylinder has also been tested. In this case, the droplets were evenly distributed between each of the cylinders, but the nitric oxide formation results would indicate that there were pockets within the cylinders devoid of the water droplets because nitric oxide concentrations averaged 100 to 500 times higher than in better-designed systems.

To understand this technology, consider the combustion chamber. Here, the charge inside the combustion chamber has been ignited by the spark plug and is beginning to propagate through the combustion chamber. Outside the arc of flame, the air/fuel mixture is filled by a mist of very tiny droplets of water. As the flame front encounters these tiny droplets, it instantly transforms them from liquid water into water vapor or steam. This phase change causes the water to expand 1400 times. In the process, a significant amount of heat energy is consumed.

Trucks

In many trucks/lorries all or most of the exhaust system is visible. Often in such trucks the silencer is surrounded by a perforated metal sheath to avoid people getting burnt touching the hot silencer. This sheath may be chrome plated as a display feature. Part of the pipe between the engine and the silencer is often flexible metal industrial ducting, as in the image in the “Terminology”.

Two-Stroke Engines

In a two-stroke engine, such as that used on dirt bikes, a bulge in the exhaust pipe known as an expansion chamber uses the pressure of the exhaust to create a pump that squeezes more air and fuel into the cylinder during the intake stroke. This provides greater power and fuel efficiency. For further info see Kadenacy effect.

Referring back to FIG. 1 which clearly shows the fuel tank No. 12 fuel and water pump No. 16, the electrolysis units eventually bank to the battery. Unlike any described in the Prior Art, the instant invention employs the electrolysis units figure No. 20 and controlling means frequency generator No. 44 or a pulse width modulator which provides an electrical means to vary duration and intensity of the electrical force that will be utilized by electrolysis units No. 20 and as a result is principally responsible for the amount of hydrogen, oxygen and water vapor liberated and for the duration for latency duration period between the production of hydrogen, oxygen and water vapor from the cleaning of the aforementioned hydrogen, oxygen and water vapor to gaseous mixture is fed to and through conduit line No. 22 which may be comprised of at least one conduit line per gas.

Pulse width modulator is directed by a combination of sensorous A, B, C and D the computer interface and computer within the vehicle and a plurality of feed back elements secondary to combustion of the gases. Please note that the applicant has set out and most preferred embodiment for the batteries, said embodiment being a lithium polymer battery No. 40 a recharge circuit that is No. 36.

While lithium polymer batteries are the preferred embodiment such other batteries as lead acid finally another element in which has not been illustrated or disclosed by the Prior Art pertaining to the direct use of hydrogen, oxygen and water vapor from the electrolysis of water vapor in fuel tank No. 12. Unlike every other embodiment the instant embodiment specifies the storage and utilization of water in its elements from there is no necessity to store any gas, hydrogen or oxygen in its gaseous form thus obviating the risk of combustion or explosion.

Every cubic foot of water contains about 1,376 cubic feet of hydrogen gas and 680 cubic feet of oxygen. Because there is no pollution produced, all smog devices may be completely removed, legally, and your car exempted from smog checks, as are propane-powered vehicles.

A hydrogen generator produces an energy potential in excess of 100 percent efficiency.

A car's battery starts the engine, but once it's running, the alternator takes over to charge the battery and power the ignition system. With an on-board hydrogen generator, that alternator also powers the hydrogen extraction process producing.

It should be noted that the instant system is capable of producing a great deal of excess heat. The heat channeled through a heat exchanger could be adapted to serve the power needs for the hydrogen engine by storing the electrical current in batteries located in different areas of the car.

HHO-fueled engine operates. Prior to the driver entering the vehicle, engine 28 in accordance with system 10 and FIG. 1 of the drawings, is in a dormant condition. Energy in the form of electricity is derived from the heat exchangers 58 provide current to operate the system 10 from battery bank 40. Therefore, when the driver enters the vehicle, and inserts the key into ignition 64 contact is made and the car's computer 62 awakens to run a series of checks. As stated heretofore, the computer is programmable so that a series of directions may be issued in response to data from the sensors 60, engine area.

A fuel tank 12 with a closure and a single direction flow valve provide access but block egress of the water fuel. The most preferred type of water is rain, snow or/distilled water, while any water may be operatively substituted without perceptible differences.

The carburetor 24 communicates with electrolysis unit 20 by way of at least a fuel line 22 so that hydrogen and oxygen gas become resident within said carburetor 24. A preferred embodiment utilizes two hoses one for each gas. The only modification to the carburetor 24 may be at least a reduction sleeve so that each gas that enters through inlet port channels a separate fuel line said reduction sleeve adapted to maintain the gases in a more intimate arrangement to encourage combustion. Along with the gases would be an amount of water vapor to not only cool engine 28 but also to add “body and mass” to the gas for better combustion.

Remaining with the same FIG. 4 there is depicted; a bifurcated fuel line that serves as a conduits for hydrogen and oxygen. It should be noted that while fuel lines are bifurcated into an oxygen and hydrogen line, providing safe containment therefore, there will be minute amounts of oxygen, hydrogen, and water vapor and even more minute by products from electrolysis. Steam will be scattered within each dedicated line. A positive pressure within lines is maintained by not only the electrolysis process within electrolysis unit 20 but also from the Turbo/Turbine unit 52.

Throttle

A throttle is the mechanism by which the flow of a fluid is managed by constriction or obstruction. An engine's power can be increased or decreased by the restriction of inlet gases (i.e. by the use of a throttle). The term throttle has come to refer, informally and incorrectly, to any mechanism by which the power or speed of an engine is regulated.

Steam

Steam has the advantage of flowing through the pipes under its own pressure without the need for pumping. For this reason, it was adopted earlier, before electric motors and pumps became available. Steam is also far easier to distribute than hot water throughout large, tall buildings like skyscrapers. However, the higher temperatures at which steam systems operate make them inherently less efficient, as unwanted heat loss in inevitably greater. Steam pipes and radiators are also prone to producing banging sounds (known as “water hammer”) if condensate fails to drain properly; this is often caused by buildings settling and the resultant pooling of condensate in pipes and radiators that no longer tilt slightly back toward the boiler.

Kinetic Energy Recovery Systems

Kinetic Energy Recovery Systems (KERS) are currently under development both for F1 motor sport and road vehicles. The concept of transferring the vehicle's kinetic energy using Flywheel energy storage was postulated by physicist Richard Feynman in the 1950s and is exemplified in complex high end systems such as the Zytek, Flybrid [⁵], Torotrak[^{6/7}] and Xtrac used in F1 and simple, easily manufactured and integrated differential based system such as the Cambridge Passenger/Commercial Vehicle Kinetic Energy Recovery System (CPC-KERS)^{[8]}

Xtrac & Flybrid are both licensees of Torotrak's technologies, which employ a small and sophisticated ancillary gearbox incorporating a continuously variable transmission (CVT). The CPC-KERS is similar as it also forms part of the driveline assembly. However, the whole mechanism including the flywheel sits entirely in the vehicle's hub (looking like a drum brake). In the CPC-KERS, a differential replaces the CVT and transfers torque between the flywheel, drive wheel and road wheel.

A reciprocating engine; also often knows as a piston engine, is a heat engine that uses one or more reciprocating pistons to convert pressure into a rotating notion. This article describes the common features of all types. The main types are the internal combustion engine, used extensively in motor vehicles; the steam engine, the mainstay of the Industrial Revolution; and the niche application Stirling engine.

These may be one or more pistons. Each piston is inside a cylinder, into which a gas is introduced, either already hot and under pressure (steam engine); or heated inside the cylinder either by ignition of a fuel air mixture (internal combustion engine) or by contact with a hot heat exchanger in the cylinder (stirling engine). The hot gases expand, pushing the piston to the bottom of the cylinder. The piston is returned to the cylinder top (Top Deal Center) either by a flywheel or the power from other pistons connected to the same shaft. In most types the expanded or “exhausted” gases are removed from the cylinder by this stroke. The exception is the Stirling engine, which repeatedly heats and cools the same sealed quantity of gas.

In some designs the piston may be powered in both directions in the cylinder in which case it is said to be double acting.

In all types the linear movement of the piston is converted to a rotating movement via a connecting rod and a crankshaft or by a swashplate. A flywheel is often used to ensure smooth rotation. The more cylinders a reciprocating engine has, generally, the more vibration-free (smoothly) it can operate. The power of a reciprocating engine is proportional to the volume of the combined pistons displacement.

A seal needs to be made between the sliding piston and the walls of the cylinder so that the high pressure gas above the piston does not leak past it.

Jet engines designs are frequently modified to turn them into gas turbine engines which are used in a wide variety of industrial applications. These include electrical power generation, powering water, natural gas, or oil pumps, and providing propulsion for ships and locomotives. Industrial gas turbine can create up to 50,000 shaft horsepower. Many of these engines are derived from older military turbojets such as the Pratt & Whitney 157 and 175 models. There is also a derivative of the P&W JT&D low-bypass turbofan that creates up to 35,000 HP.

Set out herein are the available Jet Engine types of engines.

Ramjet

Turbojet

Turbofan jet

Turboprop jet

There has thus been shown and described a novel on demand system for using water (HHO) as a sole fuel which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A system for the conversion of water to a sole source of fuel for internal combustion engines comprising:
a filler designed to add an amount of water to a fuel tank, at least a filter to separate debris from said filtered water to retained within said fuel tank;
at least a sensor and one way valve in operative communication with each other and being effective to shut off said system and to prevent further water from reaching, an electrolysis unit and sensor with an inlet means wherein said water is brought to said electrolysis unit and at least one conduit from the electrolysis unit to the inlet of the combustion sufficient to provide hydrogen, oxygen and water vapor;
a one way valve adapted to prevent backflash, situated directly before said electrolysis unit and to insure that a constant fuel source;
a fuel air chamber sufficiently positively pressurized and of a variable sized combustion chamber adapted to utilize water or Hydrogen, Oxygen, and water vapor as a sole fuel source;
at least a crankshaft or other means sufficient to convert the energy derived from combustion of HHO heat energy without forming carbon monoxide and to create mechanical power torque, thrust and the like;
a conduit to channel said heat energy to at least an exhaust system and a second heat exchange area to convert chemical energy to mechanical energy with said electrolysis unit;
at least one alternator in proximity to said electrolysis unit sufficient to provide an ongoing current to keep at least one battery fully charged at anyone time;
a plurality of electrically actuated devices sufficient to acclimatize the structure wherein said device resides said system to one or more operative values; and
a computer to act as the controller or controlling center to constantly monitor the system, sense the system take minor steps through the introduction of rescue scripts and failing to fix same effective to shut the system off whenever abherrant conditions are met.

2. A fuel as described in claim 1, further comprising water, distilled water and combinations thereof.

3. A fuel as described in claim 1, wherein the preferred fuel is distilled water.

4. At least one sensor capable of sensing conditions outside of a given value, being in operative communications with said system and being vested with an override right to maintain said system in an on or off condition.

5. A power system as described in claim 1, further comprising a plurality of alternators in operative communication with at least a battery.

6. An electrolysis unit adapted to generate hydrogen, oxygen, and water vapor, and a conduit for each or a conduit for combinations thereof, a starter engine to cycle the system and a sparking means to provide ignition thereto.

7. An exhaust system as described in claim 1, further comprised of a central system and a supplemental system, said central system and a supplemental system, said central system being essentially responsible for depositing waste energy and gases to a point remote from the system and a supplemental system responsible for creating a series of heat exchange sites.

8. an electrolysis unit as described in claim 1, wherein said unit is suspended on a mount to maintain said electrolysis unit in an upright conformation so that the perimeter boundaries stay in essentially the same attitude.

9. A system as described in claim 1, further comprising a jet engines, rotory engines, turbo jet engines, turbo fan jet engines, ram jet engines, auto engines, diesel engines, turbo diesel engines, fuel injected autos, fuel injected turbo diesel engines, two cycle engines, and axial vector type engines.

10. A system comprising a bifurcated line for providing a relaxed segregation of gases, the bifurcated line acting as a conduit to transport essentially hydrogen from one line and essentially oxygen from the other; one way valves close, and electricity is then either restored with automatic ability to dump all water if problem exceeds threshold values.
